(19) United States
(12) Patent Application Publication
(10) Pub. No.: US 2004/0109978 A1
(43) Pub. Date: Jun. 10, 2004

(54) Self-adhering support for an applied abrasive product and method for making said abrasive product incorporating same

(76) Inventor: Francois Michel, Eloyes (FR)

Correspondence Address: BIRCH STEWART KOLASCH & BIRCH, PO BOX 747, FALLS CHURCH, VA, 22040-0747, US

(21) Appl. No.: 10/467,791

(22) PCT Filed: Feb. 14, 2002
(86) PCT No.: PCT/FR02/00558

(30) Foreign Application Priority Data
Feb. 14, 2001 (FR) 01/02006

(51) Int. Cl. B32B 3/06

(52) U.S. Cl. 428/99; 428/196; 428/143

(57) ABSTRACT

The present invention relates to a self-fastening backing (A) for a coated abrasive product, comprising a backing for abrasive (1) bonded to a self-fastening sheet (1a), characterized in that the said self-fastening backing (A) has a water vapour permeability of greater than 1 g.m⁻²/24 h, particularly one bonded by a porous adhesive matrix (1b).

The invention also relates to the process for manufacturing the self-fastening coated abrasive product incorporating the said self-fastening backing.

The present invention relates to a self-fastening backing for a coated abrasive product and to the use of such a backing for the manufacture of a self-fastening coated abrasive product. The invention also relates to the process for manufacturing the said abrasive.

Within the context of the invention, the term “coated abrasive” is understood to mean an abrasive product comprising a backing, to one side of which abrasive grit particles have been bonded.

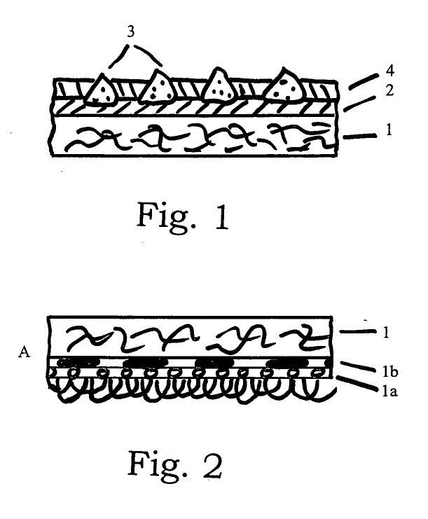

FIG. 1 shows in cross section a conventional coated abrasive product (not provided with a self-fastening face), the relative proportions of its constituent elements not being respected for the sake of greater clarity.

Referring to this FIG. 1, it will be noted that abrasive products generally comprise a backing (1) provided with two sides—the right side and the reverse side—on to one of which (the right side) have been deposited an adhesive coating (2) and then abrasive grit particles (3) covered with a size coating (4). Optionally, it is possible to add on top of the size coating (4), another coating called a supersize coating, which is an anti-clog coating containing, for example, waxes or zinc stearate.

Optionally, the abrasive product may include other coatings having a special function, for example an anti-static coating containing anti-static agents, these coatings being based on the previous coatings or between them, or on the rear face of the backing.

The backing (1) may be a paper, a nonwoven, a sized cloth or a backing based on cured fibres, these backings possibly being combined so as to provide better use characteristics.

A coated abrasive is usually produced in the manner explained below.

The adhesive coating (2) is deposited on the backing (1) by a suitable coating means, for example by roller coating.

The adhesive coat, often called “make coat” by those skilled in the art, is a composition, preferably made in aqueous medium, comprising a curable adhesive which may be a natural adhesive, such as gelatin, or synthetic resins such as phenolic, urea-formaldehyde, melamine-formaldehyde, polyurethane, epoxy, alkyd or acrylic resins, or mixtures thereof, a filler usually being added to this adhesive, in particular a mineral filler such as calcium carbonate or cryolite. It may also contain other additives such as, for example, plasticizers, colorants, wetting agents and antistatic substances.

The grit particles (3) are applied to this un-dried coat (2). These grit particles may be deposited by various means, especially by electrostatic deposition or under gravity.

These grit particles may be in particular chosen from aluminium oxide, silicon carbide, garnet, emery, cubic boron nitride or zirconium oxide; the last two are the most abrasive. The grit particles may even be in the form of aggregates which are composed of agglomerated grit particles, these aggregates having a longer lifetime and providing a more constant abrasion quality.

Those skilled in the art will choose the nature of the grit particles according to the desired type of abrasion and to the component to be abraded.

Moreover, these grit particles may have a particle size chosen according to the surface to be abraded and the level of polishing desired.

In Europe, these grit particles are usually classified according to the standard set by the FEPA (Federation of European Producers of Abrasives); the grade for a coated abrasive product has a reference beginning with a P followed by a number indicating the grit number; the greater the number the finer the grit.

Other standards may be used in other countries, especially in the USA.

Several types of grit particles may be deposited in one or more coats.

According to a variant, the composition (2) and the grit particles (3) may be deposited together if they have been preblended.

The backing thus coated undergoes a first drying operation. The resin of the composition (2) is cured during this drying.

The drying is generally carried out in a festoon oven or a linear oven. The drying temperatures and the times are chosen by those skilled in the art depending on the nature of the composition (2). Usually, this treatment is performed with temperature and moisture gradients along the oven; for example, the coat (2) with the grit particles (3) may be dried for 10 to 15 minutes between 65 and 115° C.

The next step consists in depositing a size coat (4) made from the same compounds as those used for making the adhesive coating composition (2), the size (4) being, however, less viscous than (2) so as to infiltrate well between the abrasive grit particles (3) without entirely covering the grit particles. The coat (2) and the coat (4) may be of different chemical types, it being possible to combine a coat made from gelatin with a coat made from a synthetic resin. This coat (4) enhances grit attachment.

The product obtained is then dried again and the resin of the coat (4) is partially or completely cured depending on the nature of the resin.

As previously, the drying temperatures and times are adapted according to the nature of the coat. For example, the product may be dried between 65 and 120° C. for 20 to 140 minutes in a festoon oven.

In general, after passing through the oven a second time, the product obtained is wound onto a reel, called in the term of the art a “jumbo reel”.

These reels may then be subjected to an additional post-crosslinking step depending on the nature of the resin of the coats (2) and (4). Thus, in the case of thermosetting resins, for example phenolic resins, they are treated so as to fully crosslink the coats (2) and (4) by heating the reels at a temperature of approximately 100 to 130° C. for several hours, generally from 4 to 72 hours.

In the case of resins for which this post-crosslinking step does not exist, for example in the case of urea-formaldehyde resins or of gelatin, the drying and curing are completely carried out during the second pass through the oven.

Next, the reel is left to cool, for example down to 40° C.

After this severe heat treatment, it is necessary to recondition the reverse side (the side not containing the grit particles) of the sheet of abrasive product by unreeling it in order to wet it with water optionally containing additives or with steam, and it is wound up again in the form of a reel. The reel is then left for a certain time—from a few hours to a few days—so that it becomes well rehumidified and equilibrium is achieved.

In a another step, which may be before, during or after the reconditioning step, the abrasive product may be subjected to a step called “flexing” so as to soften it in one or more directions.

The flexing is conventionally carried out by unreeling the jumbo reel and passing the sheet under or over a bar at certain angles, and then rewinding it into a jumbo reel.

The reels are then cut, if necessary, to the desired format, especially in the form of a disc, sheet or delta, or formats intended to be joined together into an endless belt.

The backing (1) is manufactured elsewhere, in a first step.

In the case of a paper backing, the paper is manufactured from cellulose fibres, possibly mixed with synthetic fibres, and it generally contains a sizing agent and optionally other conventional additives used in papermaking, such as a wet-strength agent. Furthermore, the backing may include anti-static agents or other products deposited in aqueous media by coating or impregnation, because of their solubility or coalescence, for example a polymer of the synthetic rubber type giving it flexibility.

The grammage of the backing depends on its use. The usual range of grammages lies between about 65 and 400 g/m².

The particular case of the invention relates to self-fastening coated abrasive products. Such products are used, in the form of discs, deltas, sheets or rolls to sand or abrade workpieces made of wood or metal. On that side not containing abrasive grit particles, they are provided with a self-fastening part. They can then be positioned on the sanding tools by fixing this self-fastening part to a holder provided with a gripping part complementary to that of the abrasive, as will be explained later.

The self-fastening part of a coated abrasive is usually the part called the “female” part of a self-fastening system and is present on the reverse side of the backing (1), this part being a material (a woven or nonwoven) provided with female catching elements such as pulled-out or sheared stitches, loops or plush loops, or else a nonwoven comprising bicomponent fibres, like the one described in Patent Application WO 99/65352.

The complementary part of the self-fastening system on the holder of the abrasion tool, and therefore the part referred to as the “male” part is in general a material provided with male elements, often in the form of hooks or mushrooms.

In rarer cases, it is the other way round—the female part of the self-fastening system is fixed to the holder of the abrasion tool and the male part is therefore located on the abrasive product.

By simply pressing the female part against the male part, the abrasive is fixed to the tool and can then be removed manually, by pulling with enough force. The abrasive may thus be fixed and removed several times without any appreciable reduction in the fixing power. Such self-fastening systems are for example known by the brand name VELCRO®.

The self-fastening part of the abrasive may be fastened in various ways to the reverse side of the backing (1).

One way is to fix, by lamination using an adhesive, one part of a self-fastening system, usually the female part, such as a fabric provided with sheared loops or plush loops, to the reverse side of the backing (1) once the coated adhesive has been manufactured, for example, using the process explained above.

The main drawbacks of this method are due to the fact that a product provided with abrasive grit particles is treated. This is because the self-fastening material has to be laminated at a slow rate, since the machines suffer abrasion and this material is difficult to lay down because of the relief of the grit. The grit particle size must be taken into account and the method adapted to each series of grit. Moreover, it is necessary to store the jumbo reels both upstream and downstream, these taking up a great deal of space.

Another way to remedy the presence of grit particles is to fix, by lamination, one part of a self-fastening system, usually the female part, to the backing (1) before starting the steps of converting the backing (1) into an abrasive, that is to say before undertaking the operations to deposit and fix the resins and the abrasive grit particles. The adhesive coat is continuous and solid. In general, it is in the form of a film or an extruded coat of polyolefins and weighs between 25 and 40 g/m².

However, this way has drawbacks associated with the lack of permeability of the backing during production of the abrasive since, as mentioned, because of the drying, crosslinking and rehumidification steps, the backing (1) must be capable of moisture (water or water vapour) exchange, especially if the backing has a high grammage. The problems associated with moisture exchange are greater the larger the amount of water involved. For example, a 220 g/m² paper backing must be able to allow 14 grams of water per square metre to be extracted or reabsorbed. Because the backing (1) is sandwiched between two closed coats—the make coat (2) and the adhesive coat for fastening the self-fastening part—on the one hand the extraction of water vapour is difficult and may cause blisters to appear and, on the other hand, the penetration of water or water vapour for rehumidification may be difficult. In addition, this assembly induces stresses in the backing which tend to make it warp and/or to make its edges curl up, especially when the grammage of the backing is low. In general, the range of paper backings to be used with this technique of laminating the self-fastening material is limited to grammages ranging from 150 to 185 g/m². To minimize the drawbacks of moisture exchange, the abrasive manufacturing conditions must be modified by varying the treatment times and the temperature gradients in the ovens and the rehumidification time compared with the process for a conventional coated abrasive which is not self-fastening. In certain cases, the rehumidification time may be several weeks, for example 3 weeks, instead of a few hours. Moreover, since the softening point of the adhesive must not be reached during conversion in the ovens and during crosslinking of the resin in which the grit particles are fixed, for fear of causing debonding from the backing, the choice of the said resins is also limited. Gelatin or urea-formaldehyde resins require a lower crosslinking temperature but are less strong.

The aim of the invention is to solve the abovementioned drawbacks.

In particular, one of the objectives of the invention is to be able to manufacture a self-fastening coated abrasive product with the same process settings used to manufacture a conventional coated abrasive product (one not provided with a self-fastening system).

The Applicant has found that the objective of the invention is achieved by supplying, as abrasive backing, a self-fastening backing (A) comprising a backing for abrasive (1) fastened to a self-fastening material (1a), the said backing (A) having a water vapour permeability of greater than 1 g.m⁻² per 24 hours.

More particularly, and as a preference, the backing (A) is characterized in that it comprises a backing for abrasive (1) fastened to a self-fastening material (1a) by a porous adhesive matrix (1b). Such a backing (A) is shown in cross section in FIG. 2, the relative proportions of its constituent elements not being respected for the sake of greater clarity.

The backing for abrasive (1) and the self-fastening material (1a) are therefore bonded by bonding spots or regions, such that the said bonding spots or regions are in discrete form at the bonding interface with the sheets. In particular, the discrete bonding spots or regions are uniformly distributed over the interface of the sheets.

According to one particular aspect of the invention, the adhesive is a porous adhesive. This porous adhesive may be prepared by creating pores in a known adhesive, either by the action of a chemical reaction producing a gas, before, during or after deposition of the adhesive, or by injecting an inert gas or air into the adhesive before or during its deposition on one of the sheets.

More particularly, the adhesive is in the form of a discontinuous matrix in one of the forms chosen from grids, rows, and spots. The term “spot” means a region of small area such as, for example, a somewhat oblong drop.

Preferably, the backing (A) comprises, by dry weight, from 4 to 15 g/m² of adhesive, even more preferably between about 6 and 8 g/m².

Because it is possible to use an adhesive in a small amount, it will be preferred to use a crosslinkable adhesive, its higher cost being advantageously compensated for by the small amount needed, and moreover this small amount allows better crosslinking. In addition, because of this crosslinking, the abrasive may be subjected to a wide range of temperatures and a wide selection of resins may be used for the abrasive grit particles. Preferably, the backing (A) is therefore characterized in that the adhesive can be crosslinked by heat or by moisture.

According to one particular aspect, the said adhesive is chosen from vinyl adhesives and hot-melt adhesives.

The adhesive will be chosen according to the way it is applied.

If the adhesive is deposited by a gravure coating process using a patterned cylinder, that is to say the cylinder has a pattern of uniformly spaced cells or cells in a grid or other pattern, what will be used as adhesive is an adhesive normally used in the field of paper laminating, such as certain polymers used in the form of a stable aqueous emulsion such as, in particular, polyvinyl polymers, polyacrylates, polyurethanes and styrene-butadiene copolymers, optionally carboxylated. The adhesive may be deposited at a rate of 60 m/min.

If the adhesive is applied by means of a suitable nozzle, allowing discontinuous adhesive matrices to be produced, hot-melt adhesives will be used. In this case, the adhesive may be deposited at a rate of 50 to 150 m/min.

Preferably, the adhesive is a hot-melt adhesive of the moisture-crosslinkable polyurethane type.

Preferably, the backing (A) is characterized in that the said backing (1) is chosen from sized cloth, sheets of paper or sheets of nonwoven based on cellulose fibres, optionally crosslinked, and/or on synthetic fibres.

According to one particular aspect of the invention, the backing (1) is a paper based on cellulose fibres, optionally crosslinked, and/or on synthetic fibres, and includes at least one bulk sizing agent.

Preferably, the backing (1) is characterized in that it has a grammage of between 65 and 400 g/m².

Preferably, the backing (A) is characterized in that the said self-fastening material is of the polyamide or polyolefin kind.

Preferably, the backing (A) is characterized in that the said self-fastening material has a grammage of between 30 and 105 g/m².

Preferably, the said self-fastening material (1b) is based on a woven or a nonwoven.

Preferably, the said self-fastening material (1b) is the female part of a self-fastening system. In particular, the female catching elements are pulled-out or sheared loops or plush loops, or else a nonwoven comprising bicomponent fibres.

According to one particular aspect of the invention, the said self-fastening material (1b) is the male part of a self-fastening system and more particularly the catching elements are of the mushroom type.

Preferably, the said self-fastening material (1b) has a water vapour permeability greater than 1 g.m⁻²/24 h.

The invention also relates to the use of a self-fastening backing (A) for manufacturing a self-fastening coated abrasive product using a standard process for converting a backing for abrasive into the said abrasive.

The invention also relates to the process for manufacturing the self-fastening coated abrasive obtained with the backing (A).

According to one particular aspect of the invention, the process for manufacturing a self-fastening coated abrasive product is characterized in that it comprises the following steps:

a) the backing (1), which is a paper, is manufactured by forming, on a paper machine, a sheet from an aqueous suspension comprising cellulose fibres, optionally crosslinked, and/or synthetic fibres, at least one bulk sizing agent and, optionally, conventional papermaking additives, and the sheet obtained is then dried;

b) a crosslinkable hot-melt adhesive is placed in the form of a discontinuous matrix on that face of the self-fastening material which is free of catching elements and then one of the faces of the backing (1) is applied by pressing it in order to form the self-fastening backing (A) with a permeability of 1 g.m⁻²/24 h, and, optionally, the said backing (A) is wound up;

c) the self-fastening backing (A) is converted into an abrasive, in particular by:

applying a thermosetting make coat (2) to the free face of the backing (1),

applying abrasive grit particles (3) to the undried coat (2) by conventional means, such as by electrostatic deposition or under gravity,

drying and partially heat-curing the coat (2) with the grit particles (3),

applying a thermosetting size coat (4),

drying and partially heat-curing the coat (4),

winding up the sheet of coated abrasive product,

when the resin type so requires, completing the heat curing of the coats (2) and (4) by heating the reel in an oven at around 100 to 130° C.,

letting the reel cool, for example down to about 40° C., and then

unwinding the sheet of coated abrasive product in order to recondition it by wetting it on the reverse side (the side not containing the abrasive grit particles) with water optionally containing additives or with steam and by rewinding it into a reel, thus leaving the reel to be reconditioned over a few hours to a few days, and/or to subject it to a flexing step.

More particularly, in step b), on the one hand, a moisture-crosslinkable adhesive, in particular a polyurethane, is applied in an amount from 4 to 15 g/m², preferably between about 6 and 8 g/m², by dry weight by means of a nozzle for depositing a discontinuous adhesive matrix and, on the other hand, the reeled self-fastening backing (A) is left to crosslink for a few days and up to about 8 days.

According to another particular aspect of the invention, the process for manufacturing a self-fastening coated abrasive product is characterized in that it comprises the following steps:

a) the backing (1), which is a paper, is manufactured by forming, on a paper machine, a sheet from an aqueous suspension comprising cellulose fibres, optionally crosslinked, and/or synthetic fibres, at least one bulk sizing agent and, optionally, conventional papermaking additives, and the sheet obtained is then dried;

b) an adhesive in the form of a discontinuous matrix is placed on one of the faces of the backing (1) and then that face of the self-fastening material which is free of the catching elements is applied to this adhesive by pressing it in order to form the self-fastening backing (A) with a permeability of 1 g.m⁻²/24 h, and optionally, the said backing (A) is wound up;

c) the self-fastening backing (A) is converted into an abrasive, in particular by:

applying a thermosetting make coat (2) to the free face of the backing (1),

applying abrasive grit particles (3) to the undried coat (2) by conventional means, such as by electrostatic deposition or under gravity,

drying and partially heat-curing the coat (2) with the grit particles (3),

applying a thermosetting size coat (4),

drying and partially heat-curing the coat (4),

winding up the sheet of coated abrasive product,

when the resin type so requires, completing the heat curing of the coats (2) and (4) by heating the reel in an oven at around 100 to 130° C.,

letting the reel cool, for example down to about 40° C., and then

unwinding the sheet of coated abrasive product in order to recondition it by wetting it on the reverse side (the side not containing the abrasive grit particles) with water optionally containing additives or with steam and by rewinding it into a reel, thus leaving the reel to be reconditioned over a few hours to a few days, and/or to subject it to a flexing step.

More particularly, in this step b), on the one hand, an adhesive in an aqueous medium is applied in an amount from 4 to 15 g/m², preferably between about 6 and 8 g/m², by dry weight, by means of a gravure-type coater with a patterned cylinder for depositing a discontinuous adhesive matrix and, on the other hand, the self-fastening backing (A) is dried before optionally being wound up.

The invention will be more clearly understood with the aid of the following nonlimiting examples.

### EXAMPLE 1

Production of the Self-Fastening Backing (A):

A backing (1), which was a paper, was produced in a first step. The paper was produced in a first step. The paper was produced on a wire-table paper machine as follows:

A suspension of cellulose fibres refined to 37° SR was prepared in aqueous medium, to which an internal sizing agent, such as colophony fixed by aluminium sulphate, was added.

The sheet obtained was dried.

The grammage of the finished paper was 120 g/m².

In a second step, the paper backing (1) was laminated to a jersey-knitted polyamide self-fastening fabric (1b), having sheared stitches as catching elements, by means of an adhesive (1a) in the following manner:

A moisture-crosslinkable polyurethane adhesive (adhesive 1a) was deposited on the opposite side of the self-fastening fabric to that having the sheared stitches in an amount of 7 g/m² by dry weight by means of a nozzle discontinuously depositing the adhesive hot, between 90 and 140° C., in the form of oblong droplets. The areas of adhesive were between 0.5 and 1 mm in width and the areas without adhesive, between two areas of adhesive, were of the order of 1 mm. Next, the paper was applied to the adhesive-coated side of the fabric by pressing. The complex obtained was wound up. The adhesive was left to crosslink, for a time of between 3 and 7 days, so that the cohesion between the paper and the self-fastening material was greater than 150 cN/cm. The polyurethane adhesive used had a THERMOSELL DGA viscosity at 2920 rpm and at 130° C. of between 5000 and 50 000 mPa.s, according to the ASTM 3236 standard.

Final Production of the Coated Abrasive Product:

An abrasive produce was produced from the backing (A) made above.

The backing was coated by means of a roll coater with a conventional aqueous adhesive composition, comprising a thermosetting urea-formaldehyde resin and calcium carbonate as filler. The total solids content of this composition was 58%. Water was added to adjust the viscosity to 2.5 Pa.s (2500 cps) AT 25° C. The amount deposited was 17 g/m² by dry weight.

Immediately after this composition (2) was deposited, conventional alumina abrasive grit particles (P220 grit) were deposited electrostatically. The amount deposited was 98 g/m² by dry weight.

The paper thus coated was dried in a festoon oven with a temperature gradient between 60 and 80° C., for fifteen minutes, so as to dry the paper and partially crosslink the resin of (2).

Next, a size composition (4) based on a phenol-formaldehyde resin, made in the same way as (2) but with a viscosity of 1 Pa.s (1000 cps) at 25° C., was applied to this coated paper by means of a roll coater; the total solids content of this composition was 54%. The amount of resin (4) deposited was 30 g/m² by dry weight.

The paper thus coated was again dried in a festoon oven with a temperature gradient between 70 and 120° C., for 45 minutes, so as to dry the paper and partially crosslink the resin (4). The sheet was wound up into a jumbo reel.

This jumbo reel was heated for four hours at 120° C. so as to complete the thermal curing of the coats (2) and (4) to the desired hardness. The relative moisture content of the product was then 0.5%. In order for the abrasive product to have its properties restored, the said product was reconditioned for a few hours, in conjunction with a flexing step, by spraying water so that it reabsorbed 7 g of water per square metre.

The jumbo reel thus obtained was cut into self-fastening discs for a sander fitted with a complementary self-fastening holder. The discs obtained were flat and uniform.

### COMPAATIVE EXAMPLE 2

A self-fastening backing was produced by laminating the paper backing (1) of Example 1 to a self-fastening material similar to that of Example 1 but having a higher grammage, in this case 65 g/m², by means of an adhesive coat. The adhesive coat was continuously deposited on one side of the paper by extruding an ethylene/vinyl acetate copolymer in an amount of 35 g/m². The self-fastening material was applied to the adhesive coat so as to embed the base of the catching elements in order to have good adhesion, while leaving the said elements free to catch. The self-fastening material used here had a grammage greater than that of Example 1, since if it has been as light and thin as in Example 1 the material would have been completely buried in the adhesive coat. Next, the backing obtained was converted into a coated abrasive in a manner similar to Example 1, however problems of bubbling were observed, which bubbles formed blisters in the backing, particularly along the edges of the width, during drying in the second festoon oven. Moreover, the reconditioning was difficult and non-uniform, even after three weeks. The discs cut from this abrasive sheet had non-flat areas because of the non-uniformity of the reconditioning.

### TESTS AND RESULTS

Table 1 gives the main characteristics of the components of the self-fastening backings of Examples 1 and 2 and of the said backings, just before they are converted into a coated abrasive. The measured characteristics were the following:

the grammage, determined according to the international ISO 536 standard, of the backing (1), of the self-fastening materials and of the self-fastening backings obtained;

the weight of adhesive deposited for bonding the paper to the self-fastening material;

the air permeance or porosity, determined according to the ISO 5636-5 standard and expressed in Gurley seconds per 100 cm³ of air;

the water vapour permeability of the backings (A), determined according to the ISO 2528 standard and expressed in g.m⁻² per 24 h.

The self-fastening materials used in the examples had the same permeability, which was 24 g.m⁻²/24 h.

Table 2 shows the rate of wet reconditioning of the backings (A), the conversion of which into a coated abrasive product was simulated in terms of moisture exchange. To do this, we deposited, on the self-fastening backings and the base backing (1), only an adhesive tape with the reference “Scotch Brand Tape, 3M ref. 396” 102 mm in width, over the entire surface of the side intended to receive the resin and the grit particles of each specimen.

This polyester-based adhesive tape was impermeable to water vapour and to water, and therefore simulated the water vapour and water impermeability property of the two coats of resin heat-cured to retain the abrasive grits.

In this case, water exchanges could only take place via the opposite side to the grits, i.e. that having the self-fastening fabric in Example 1 and Comparative Example 2 (or the paper side in the case of just the base paper).

The operating method was as follows: each of the two self-fastening backings of Example 1 and Comparative Example 2 and the paper backing (1) alone were placed in an oven at 105° C. for two hours so as to evaporate most of the water contained in the paper. Next, the specimens were removed from the oven, the adhesive tape applied to each of them on that face intended to receive the coats and the grits, and the complexes obtained were dried again in an oven at 105° C. for twelve hours. The complexes thus dried were then removed from the oven and immediately weighed, then placed in an air-conditioned room at 23° C. and 50% relative humidity, and then weighed at regular time intervals in order to monitor the change in moisture uptake. The moisture uptake of the self-fastening materials was also determined—the maximum uptake was reached rapidly, after five minutes. It was 1.3 g/m² in the case of the material used in Example 1 and 1.9 g/m² in the case of that used in Comparative Example 2.

Table 2 shows the change in moisture uptake with respect to the base backing (1) by deducing the respective moisture uptake of the self-fastening materials, the values being expressed in g/m².

To ensure that the adhesive tape also had a low permeability, this operating method was also applied to the base paper alone, by applying the adhesive tape over one entire side, drying the complex for two hours at 105° C., applying a 2nd adhesive tape to the other entire side, drying this new complex for twelve hours, weighing this new complex immediately afterwards and then, as described above, measuring its moisture uptake in an air-conditioned room at 23° C. and 50% RH.

The self-fastening backing (A) of Example 1 according to the invention had a rapid rate of moisture uptake, similar to that of the one-side adhesive-coated backing (1) and therefore similar to that of a standard paper backing for abrasives (i.e. one which is not self-fastening). A backing (A) according to the invention will therefore be suitable for conversion into an abrasive product using a standard process. In contrast, the self-fastening backing according to the prior art of Comparative Example 2 had a very slow rate of moisture uptake.

TABLE 1

| | | | Comparative |
|---|---|---|---|
| | Backing (1) | Example 1 | Example 2 |
| Grammage of | 120 | 120 | 120 |
| the backing | | | |
| (1) | | | |
| (g/m²) | | | |
| Grammage of the | — | 45 | 65 |
| self-fastening | | | |
| material | | | |
| (g/m²) | | | |
| Weight of | — | 7 | 35 |
| adhesive | | | |
| (g/m²) | | | |
| Grammage of | — | 172 | 220 |
| the | | | |
| self-fastening | | | |
| backing | | | |
| (g/m²) | | | |
| Gurley | 2100 | 2300 | >10,000 |
| porosity | | | |
| (s) | | | |
| Water vapour | 8.1 | 7.4 | 0.1 |
| permeability | | | |
| (g · m⁻²/24 h) | | | |

TABLE 2

| | | | | 2-side |
|---|---|---|---|---|
| | | | | adhesive- |
| | | | | coated |
| Time | 1-side adhesive-coated | | Comparative | backing |
| (min) | backing (1) | Example 1 | Example 2 | (1) |
| 10 | 3.0 | 0.7 | 0.1 | 0.9 |
| 15 | 3.7 | 2.5 | 0.2 | 1.0 |
| 30 | 4.3 | 4.7 | 0.3 | 1.1 |
| 45 | 5.8 | 5.9 | 0.5 | 1.5 |
| 60 | 6.4 | 6.8 | 0.7 | 1.6 |
| 90 | 7.1 | 7.7 | 0.8 | 1.8 |
| 120 | 7.4 | 8.1 | 1.0 | 2.2 |
| 210 | 8.3 | 8.3 | 1.6 | 2.1 |
| 300 | 8.5 | 8.5 | 1.8 | 2.1 |
| 360 | 8.5 | 8.5 | 2.1 | 2.3 |
| 14,400 | 8.6 | 8.5 | 4.8 | 4.6 |

1. Self-fastening backing (A) for a coated abrasive product comprising a backing for abrasive (1) fastened to a self-fastening material (1a), the said backing (A) having a water vapour permeability of greater than 1 g.m⁻² per 24 hours.

2. Self-fastening backing (A) according to the preceding claim, characterized in that it comprises a backing for abrasive (1) fastened to a self-fastening material (1a) by a porous adhesive matrix (1b).

3. Self-fastening backing (A) according to the immediately preceding claim, characterized in that the adhesive is in the form of a discontinuous matrix in one of the forms chosen from grids, rows, and spots.

4. Self-fastening backing (A) according to either of claims 2 and 3, characterized in that it comprises, by dry weight, from 4 to 15 g/m² of adhesive, even more preferably between about 6 and 8 g/m².

5. Self-fastening backing (A) according to one of claims 2 to 4, characterized in that the adhesive is heat-crosslinkable or moisture-crosslinkable.

6. Self-fastening backing (A) according to one of claims 2 to 5, characterized in that the said adhesive is chosen from vinyl adhesives and hot-melt adhesives.

7. Self-fastening backing (A) according to claim 6, characterized in that the adhesive is a hot-melt adhesive based on a moisture-crosslinkable polyurethane.

8. Self-fastening backing (A) according to one of claims 1 to 6, characterized in that the, said backing (1) is chosen from sized cloth, sheets of paper or sheets of nonwoven based on cellulose fibres, optionally crosslinked, and/or on synthetic fibres.

9. Self-fastening backing (A) according to one of claims 1 to 8, characterized in that the backing (1) has a grammage of between 65 and 400 g/m²

10. Self-fastening backing (A) according to one of claims 1 to 9, characterized in that the said self-fastening material (1b) has a water vapour permeability greater than 1 g.m⁻² per 24 hours.

11. Self-fastening backing (A) according to one of claims 1 to 10, characterized in that the self-fastening material has a grammage of between 30 and 105 g/m².

12. Self-fastening backing (A) according to one of claims 1 to 11, characterized in that the said self-fastening material is of the polyamide or polyolefin kind.

13. Self-fastening backing (A) according to one of claims 1 to 12, characterized in that the said self-fastening material (1b) is based on woven or a nonwoven.

14. Self-fastening backing (A) according to one of claims 1 to 13, characterized in that the said self-fastening material (1b) is the female part of a self-fastening system.

15. Self-fastening backing (A) according to one of claims 1 to 13, characterized in that the said self-fastening material (1b) is the male part of a self-fastening system, in particular the catching elements are of the mushroom type.

16. Use of a self-fastening backing (A) according to one of the preceding claims to manufacture a self-fastening coated abrasive product using a standard process for converting a backing for abrasive into the said abrasive.

17. Process for manufacturing a self-fastening coated abrasive product characterized in that it comprises the following steps:
a) the backing (1), which is a paper, is manufactured by forming, on a paper machine, a sheet from an aqueous suspension comprising cellulose fibres, optionally crosslinked, and/or synthetic fibres, at least one bulk sizing agent and, optionally, conventional papermaking additives, and the sheet obtained is then dried;
b) a crosslinkable hot-melt adhesive is placed in the form of a discontinuous matrix on that face of the self-fastening material which is free of catching elements and then one of the faces of the backing (1) is applied by pressing it in order to form the self-fastening backing (A) with a permeability of 1 g.m⁻²/24 h, and, optionally, the said backing (A) is wound up;
c) the self-fastening backing (A) is converted into an abrasive, in particular by:
applying a thermosetting make coat (2) to the free face of the backing (1),
applying abrasive grit particles (3) to the undried coat (2) by conventional means, such as by electrostatic deposition or under gravity,
drying and partially heat-curing the coat (2) with the grit particles (3),
applying a thermosetting size coat (4),
drying and partially heat-curing the coat (4),
winding up the sheet of coated abrasive product,
when the resin type so requires, completing the heat curing of the coats (2) and (4) by heating the reel in an oven at around 100 to 130° C.,
letting the reel cool, for example down to about 40° C., and then
unwinding the sheet of coated abrasive product in order to recondition it by wetting it on the reverse side (the side not containing the abrasive grit particles) with water optionally containing additives or with steam and by rewinding it into a reel, thus leaving the reel to be reconditioned over a few hours to a few days, and/or to subject it to a flexing step.

18. Manufacturing process according to claim 17, characterized in that in step b), on the one hand, a moisture-crosslinkable adhesive, in particular a polyurethane, is applied in an amount from 4 to 15 g/m², preferably between about 6 and 8 g/m², by dry weight by means of a nozzle for depositing a discontinuous adhesive matrix and, on the other hand, the reeled self-fastening backing (A) is left to crosslink for a few days and up to about 8 days.

19. Process for manufacturing a self-fastening coated abrasive product characterized in that it comprises the following steps:
a) the backing (1), which is a paper, is manufactured by forming, on a paper machine, a sheet from an aqueous suspension comprising cellulose fibres, optionally crosslinked, and/or synthetic fibres, at least one bulk sizing agent and, optionally, conventional papermaking additives, and the sheet obtained is then dried;
b) An adhesive in the form of a discontinuous matrix is placed on one side of the backing (1) and then that side of the self-fastening material which is free of the catching elements is applied to this adhesive by pressing, in order to form the self-fastening backing (A) with a permeability of 1 g.m⁻²/24 h, and optionally, the said backing (A) is wound up;
c) the self-fastening backing (A) is converted into an abrasive, in particular by:
applying a thermosetting make coat (2) to the free face of the backing (1),
applying abrasive grit particles (3) to the undried coat (2) by conventional means, such as by electrostatic deposition or under gravity,
drying and partially heat-curing the coat (2) with the grit particles (3),
applying a thermosetting size coat (4),
drying and partially heat-curing the coat (4),
winding up the sheet of coated abrasive product,
when the resin type so requires, completing the heat curing of the coats (2) and (4) by heating the reel in an oven at around 100 to 130° C.,
letting the reel cool, for example down to about 40° C., and then
unwinding the sheet of coated abrasive product in order to recondition it by wetting it on the reverse side (the side not containing the abrasive grit particles) with water optionally containing additives or with steam and by rewinding it into a reel, thus leaving the reel to be reconditioned over a few hours to a few days, and/or to subject it to a flexing step.

20. Manufacturing process according to claim 19, characterized in that in this step b), on the one hand, an adhesive in an aqueous medium is applied in an amount from 4 to 15 g/m², preferably between about 6 and 8 g/m², by dry weight, by means of a gravure-type coater with a patterned cylinder for depositing a discontinuous adhesive matrix and, on the other hand, the self-fastening backing (A) is dried before optionally being wound up.
